(19) United States
(12) Patent Application Publication
(10) Pub. No.: US 2016/0033984 A1
(43) Pub. Date: Feb. 4, 2016

(54) VOLTAGE REGULATOR HAVING SOURCE VOLTAGE PROTECTION FUNCTION

(71) Applicant: SAMSUNG ELECTRO-MACHANICS CO., LTD., Suwon-si (KR)

(72) Inventor: Soo Woong LEE, Suwon-si (KR)

(73) Assignee: SAMSUNG ELECTRO-MECHANICS CO., LTD., Suwon-si (KR)

(21) Appl. No.: 14/659,779

(22) Filed: Mar. 17, 2015

(30) Foreign Application Priority Data
Jul. 29, 2014 (KR) 10-2014-0096723

(51) Int. Cl. G05F 1/575

(52) U.S. Cl. CPC G05F 1/575

(57) ABSTRACT

A voltage regulator having a source voltage protection function may include an error amplifying unit providing a gate signal depending on a difference in voltage levels between a reference voltage and a feedback voltage, a current adjusting unit adjusting a current between a source input terminal receiving a source voltage and a ground in response to the gate signal, a feedback circuit unit detecting the feedback voltage in a feedback node between the current adjusting unit and the ground, an over-voltage protection unit shutting the current adjusting unit down when an over-voltage condition is detected in the source voltage, and an under-voltage protection unit shutting the current adjusting unit down when an under-voltage condition is detected in the source voltage.

### CROSS-REFERENCE TO RELATED APPLICATION

This application claims priority to, and the benefit of, Korean Patent Application No. 10-2014-0096723 filed on Jul. 29, 2014, with the Korean Intellectual Property Office, the disclosure of which is incorporated herein by reference.

### BACKGROUND

The present disclosure relates to a low-dropout (LDO) type voltage regulator having a protection function for over-voltage and under-voltage of a source voltage.

In general, a voltage regulator may be used in a power amplifier in order to stably control operations of the power amplifier. Particularly, among the voltage regulators, a low-dropout (LDO) type voltage regulator may be used to down-convert a source voltage, having simplicity in terms of the design thereof, and reduced current consumption.

When a voltage of power from an external power source increases to become an over-voltage exceeding a normal range of power from the external power source or drops to become an under-voltage that is lower than the normal range of power from the external power source, the LDO type voltage regulators may need an over-voltage protection circuit, an under-voltage protection circuit, and the like, in order to protect a system from the over-voltage or under voltage.

An existing LDO type voltage regulator performs a down-conversion of the source voltage and does not provide an additional protection from over-voltages and under-voltages.

Therefore, since the existing LDO type voltage regulators do not have over-voltage and under-voltage protection circuits included therein, over-voltage protection circuits and under-voltage protection circuits are provided outside of LDO type voltage regulators, independently of LDO type voltage regulators. As a result, since a separate control process for performing a protection operation on the outside is additionally required, the control thereof may be relatively complex.

In addition, since the voltage regulator does not directly perform the protection function, and, as a result, may be directly supplied with an over-voltage or an under-voltage outside of a stable operating range, such as the over-voltage, the under-voltage, or the like, there is vulnerability to the protection function and consequently, reliability of the circuit may be degraded.

The following Related Art Document (Patent Document 1), which relates to an over-current protection circuit of a low voltage regulator, does not disclose a technical feature performing a protection from an over-voltage and an under-voltage condition in an operation voltage.

### RELATED ART DOCUMENT

(Patent Document 1) Korean Patent Laid-Open Publication No. 2010-0083871

### SUMMARY

An aspect of the present disclosure may provide a low-dropout (LDO) type voltage regulator having a protection function for an over-voltage and an under-voltage of a source voltage.

According to an aspect of the present disclosure, a voltage regulator having a source voltage protection function may include: an error amplifying unit providing a gate signal depending on a difference in voltage levels between a reference voltage and a feedback voltage; a current adjusting unit adjusting a current between a source voltage terminal that receives a source voltage and a ground, in response to the gate signal; a feedback circuit unit detecting the feedback voltage in a feedback node between the current adjusting unit and the ground; an over-voltage protection unit shutting the current adjusting unit down when an over-voltage condition in the source voltage is determined; and an under-voltage protection unit shutting the current adjusting unit down when an under-voltage condition in the source voltage is determined.

The over-voltage protection unit and the under-voltage protection unit may respectively include a hysteresis comparator performing a protection operation to protect a system and an operation to release the protection operation, based on different threshold voltages.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a first illustrative block diagram illustrating a configuration of a voltage regulator according to an exemplary embodiment of the present disclosure;

FIG. 2 is a second illustrative block diagram illustrating the configuration of the voltage regulator according to an exemplary embodiment of the present disclosure;

FIG. 3 is a third illustrative block diagram illustrating the configuration of the voltage regulator according to an exemplary embodiment of the present disclosure;

FIG. 4 is a diagram of a bandgap reference voltage generating unit according to an exemplary embodiment of the present disclosure;

FIG. 5 is a first illustrative implementation diagram for main parts of the voltage regulator according to an exemplary embodiment of the present disclosure;

FIG. 6 is a second illustrative implementation diagram for the main parts of the voltage regulator according to an exemplary embodiment of the present disclosure;

FIG. 7 is a hysteresis curve diagram of an over-voltage protecting unit according to an exemplary embodiment of the present disclosure; and

FIG. 8 is a hysteresis curve diagram of an under-voltage protecting unit according to an exemplary embodiment of the present disclosure.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

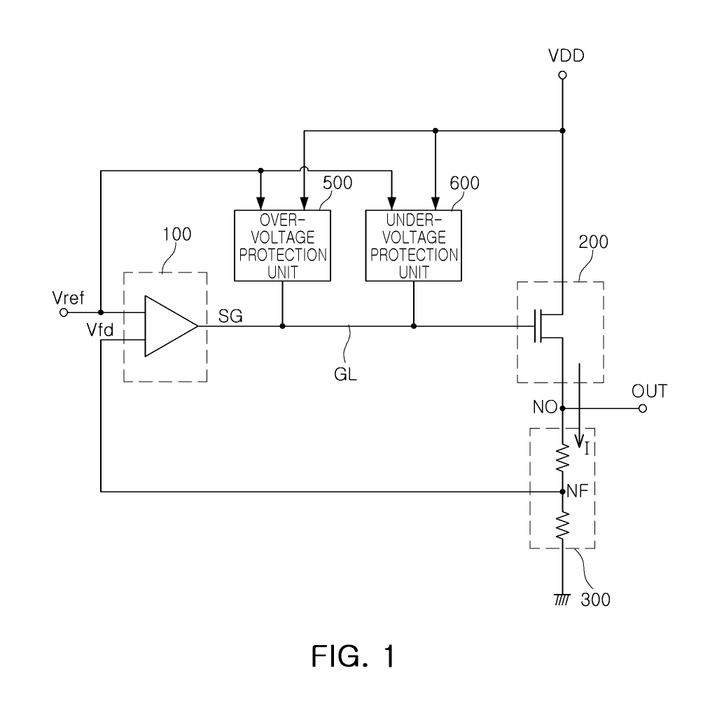

FIG. 1 is a first illustrative block diagram illustrating a configuration of a voltage regulator according to an exemplary embodiment of the present disclosure.

Referring to FIG. 1, the voltage regulator according to an exemplary embodiment of the present disclosure may include an error amplifying unit 100, a current adjusting unit 200, a feedback circuit unit 300, an over-voltage protection unit 500, and an under-voltage protection unit 600.

In addition, as illustrated in FIG. 1, the voltage regulator according to an exemplary embodiment of the present disclosure may include the over-voltage protection unit 500 and the under-voltage protection unit 600 so as to directly perform a protection function for an over-voltage and an under-voltage of a source voltage. The above-mentioned description may be applied to all of the respective exemplary embodiments of the present disclosure.

The error amplifying unit 100 may provide a gate signal depending on a difference in voltage levels between a reference voltage Vref and a feedback voltage Vfb.

As an example, the error amplifying unit 100 may include an operational amplifier having a first input terminal that receives the reference voltage Vref, a second input terminal that receives the feedback voltage Vfb, and an output terminal that provides the gate signal SG.

Here, the error amplifying unit 100 and the current adjusting unit 200 may be connected to each other through a gate line GL, and the gate signal SG output from the error amplifying unit 100 may be transferred to the current adjusting unit 200 through the gate line GL.

The current adjusting unit 200 may adjust a current I between a source voltage VDD terminal supplied with a source voltage VDD and a ground, in response to the gate signal SG.

As an example, the current adjusting unit 200 may include an MOS transistor having a gate that receives the gate signal SG, and a source and a drain that are connected to the source voltage VDD terminal and the feedback circuit unit 300, respectively. Here, the MOS transistor may be a PMOS transistor or an NMOS transistor.

The feedback circuit unit 300 may detect the feedback voltage Vfd in a feedback node NF between the current adjusting unit 200 and the ground so as to provide the detected feedback voltage Vfd to the error amplifying unit 100.

As an example, the feedback circuit unit 300 may include at least two resistors that are connected in series with each other between the current adjusting unit 200 and the ground, and a connection node between the at least two resistors may be the feedback node NF.

Meanwhile, an output node NO, which is a connection node between the current adjusting unit 200 and the feedback circuit unit 300, may be connected to an output terminal OUT. In this case, a circuit unit for stabilizing an output voltage Vout may be added between the output node NO and the output terminal OUT.

The over-voltage protection unit 500 may shutdown the current adjusting unit 200 when the over-voltage condition in the source voltage VDD is determined. Here, the shutdown means stopping an operation of the current adjusting unit 200.

As an example, the over-voltage protection unit 500 may generate an threshold voltage exceeded signal VH based on the reference voltage Vref and may determine that the source voltage VDD is the over-voltage, based on the source voltage VDD and the threshold voltage exceeded signal VH.

For example, in the case in which the source voltage VDD exceeds the threshold voltage exceeded signal VH, the over-voltage protection unit 500 may determine the source voltage VDD as the over-voltage to thereby shutdown the current adjusting unit 200.

The under-voltage protection unit 600 may shutdown the current adjusting unit 200 when the under-voltage condition in the source voltage VDD is determined.

As an example, the under-voltage protection unit 600 may generate an under threshold voltage signal VL based on the reference voltage Vref and may determine that the source voltage VDD is the under-voltage, based on the source voltage VDD and the under threshold voltage signal VL.

For example, in the case in which a level of the source voltage VDD is less than that of the under threshold voltage signal VL, the under-voltage protection unit 600 may determine the source voltage VDD as the under-voltage to thereby shutdown the current adjusting unit 200.

The over-voltage protection unit 500 and the under-voltage protection unit 600 illustrated in FIG. 1 as described above may respectively include a hysteresis comparator performing a protection operation and a release operation of the protection operation based on different threshold voltages.

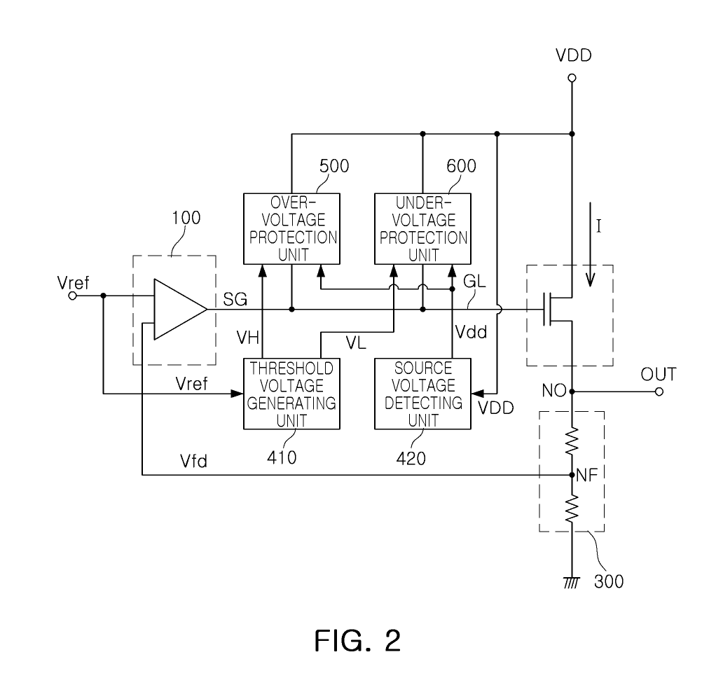

FIG. 2 is a second illustrative block diagram illustrating the configuration of the voltage regulator according to an exemplary embodiment of the present disclosure.

Referring to FIG. 2, the voltage regulator according to an exemplary embodiment of the present disclosure may include the error amplifying unit 100, the current adjusting unit 200, the feedback circuit unit 300, a threshold voltage generating unit 410, a source voltage detecting unit 420, the over-voltage protection unit 500, and the under-voltage protection unit 600.

Among the operations of the error amplifying unit 100, the current adjusting unit 200, and the feedback circuit unit 300 illustrated in FIG. 2, a description of overlapped operations of the same operations as those described with reference to FIG. 1 will be omitted.

In addition, as illustrated in FIG. 2, since the voltage regulator according to an exemplary embodiment of the present disclosure includes the threshold voltage generating unit 410 and the source voltage detecting unit 420 that are able to autonomously and directly generate a threshold voltage and directly and simply detect a source voltage, without being supplied with the threshold voltage and the detection voltage from the outside, the voltage regulator may be more simply implemented and operated, and consequently, advantages in terms of size and price thereof may be provided. The above-mentioned description may be applied to all of the respective exemplary embodiments of the present disclosure.

The threshold voltage generating unit 410 may generate an threshold voltage exceeded signal VH and an under threshold voltage signal VL based on the reference voltage Vref.

As an example, the threshold voltage generating unit 410 may generate the threshold voltage exceeded signal VH and then under threshold voltage signal VL by dividing the reference voltage Vref using a plurality of resistors.

The source voltage detecting unit 420 may detect the source voltage VDD so as to provide a source detection voltage Vdd.

As an example, the source voltage detecting unit 420 may provide the source detection voltage Vdd by dividing the source voltage VDD using the plurality of resistors.

The over-voltage protection unit 500 may shutdown the current adjusting unit 200 when the over-voltage condition in the source voltage is determined, based on the source detection voltage Vdd and the threshold voltage exceeded signal VH.

As an example, in the case in which a level of the source detection voltage Vdd is higher than that of the threshold voltage exceeded signal VH, the over-voltage protection unit 500 may determine the source voltage VDD as the over-voltage.

The under-voltage protection unit 600 may shutdown the current adjusting unit 200 when the under-voltage condition in the source voltage VDD is determined, based on the source detection voltage Vdd and the under threshold voltage signal VL.

As an example, in the case in which a level of the source detection voltage Vdd is lower than that of the under threshold voltage signal VL, the under-voltage protection unit 600 may determine the source voltage VDD as the under-voltage.

The over-voltage protection unit 500 and the under-voltage protection unit 600 illustrated in FIG. 2 as described above may respectively include a hysteresis comparator performing a protection operation and a release operation of the protection operation based on different threshold voltages.

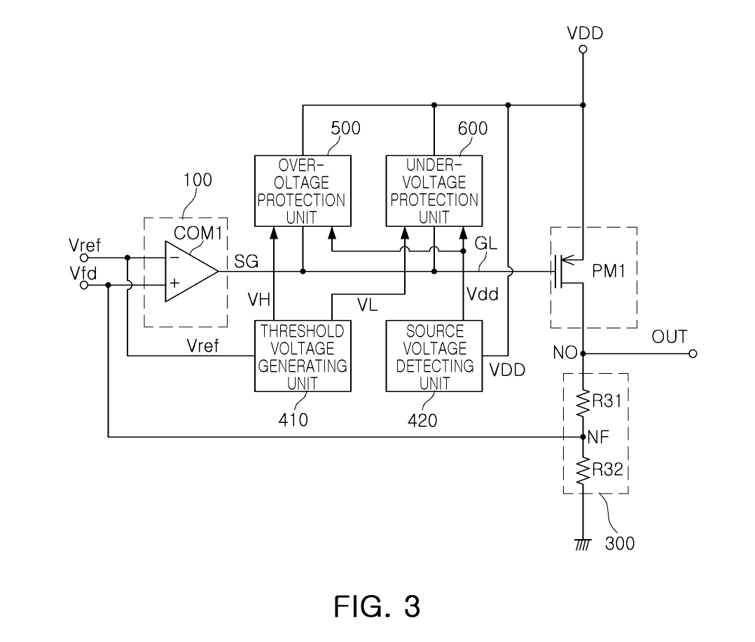

FIG. 3 is a third illustrative block diagram illustrating the configuration of the voltage regulator according to an exemplary embodiment of the present disclosure.

Referring to FIG. 3, the voltage regulator according to an exemplary embodiment of the present disclosure may include the error amplifying unit 100, the current adjusting unit 200, the feedback circuit unit 300, the threshold voltage generating unit 410, the source voltage detecting unit 420, the over-voltage protection unit 500, and the under-voltage protection unit 600.

Among the operations of the threshold voltage generating unit 410, the source voltage detecting unit 420, the over-voltage protection unit 500, and the under-voltage protection unit 600 illustrated in FIG. 3, a description of overlapped operations of the same operations as those described with reference to FIG. 2 will be omitted.

Referring to FIG. 3, the error amplifying unit 100 may include an operational amplifier COM1 having an inverting input terminal that receives the reference voltage Vref, a non-inverting input terminal that receives the feedback voltage Vfb, and an output terminal that provides the gate signal SG, by way of example.

In this case, the error amplifying unit 100 may provide the gate signal SG having a level depending on magnitude of a difference in voltage levels between the reference voltage Vref and the feedback voltage Vfb.

As an example, the current adjusting unit 200 may include a PMOS transistor PM1 having a gate that receives the gate signal SG, a source connected to the source voltage VDD terminal, and a drain connected to the feedback circuit unit 300. In this case, the PMOS transistor PM1 may adjust a current I flowing through a source-drain of the PMOS transistor PM1 depending on a voltage level of the gate signal SG.

As an example, the feedback circuit unit 300 may include at least two resistors R31 and R32 that are connected in series with each other between the current adjusting unit 200 and the ground, and a connection node between the at least two resistors R31 and R32 may be the feedback node NF.

As described above, although the example of an implementation circuit of each of the error amplifying unit 100, the current adjusting unit 200, and the feedback circuit unit 300 has been described with reference to FIG. 3, it is merely an illustrative example and the present disclosure is not limited thereto.

Therefore, each of the error amplifying unit 100, the current adjusting unit 200, and the feedback circuit unit 300 may be implemented as various circuits as long as it performs the respective basic operations as described above.

The over-voltage protection unit 500 and the under-voltage protection unit 600 illustrated in FIG. 3 as described above may respectively include a hysteresis comparator performing a protection operation and a release operation of the protection operation based on different threshold voltages.

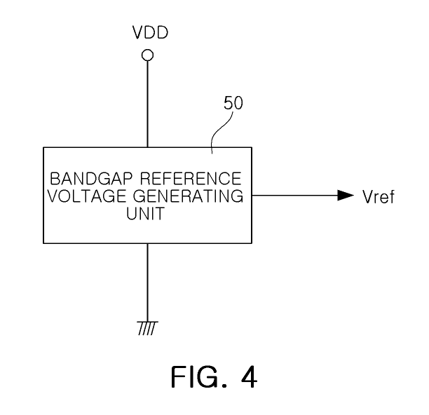

FIG. 4 is a diagram of a bandgap reference voltage generating unit according to an exemplary embodiment of the present disclosure.

Referring to FIG. 4, the reference voltage Vref may be generated by a bandgap reference voltage generating unit 50. The bandgap reference voltage generating unit 50 may be implemented as a bandgap reference voltage source that is known in the art and uses a typical zener diode, by way of example.

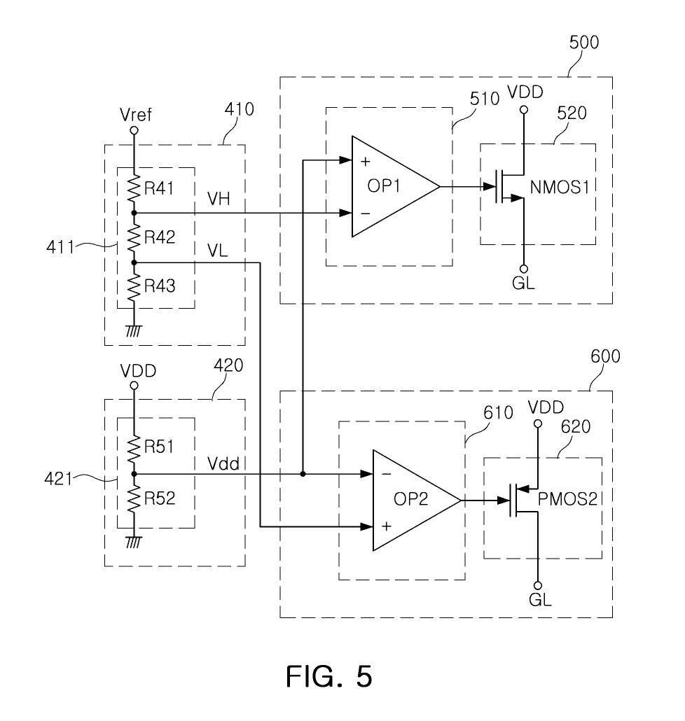

FIG. 5 is a first illustrative implementation diagram for main parts of the voltage regulator according to an exemplary embodiment of the present disclosure.

Referring to FIG. 5, the threshold voltage generating unit 410 may include a first voltage dividing circuit 411 having at least three resistors R41, R42, and R43 which are connected in series with each other between the reference voltage Vref terminal and the ground, by way of example.

The first voltage dividing circuit 411 may divide the reference voltage Vref so as to provide the threshold voltage exceeded signal VH at a connection node between the two resistors R41 and R42 among the three resistors and to provide the under threshold voltage signal VL at a connection node between the resistors R42 and R43 among the three resistors.

The source voltage detecting unit 420 may include a second voltage dividing circuit 421 having at least two resistors R51 and R52 which are connected to each other between the a source voltage VDD terminal that receives the source voltage VDD and the ground, by way of example.

The second voltage dividing circuit 421 may divide the source voltage VDD so as to provide the source detection voltage Vdd at a connection node between the at least two resistors R51 and R52.

As an example, the over-voltage protection unit 500 may shutdown the current adjusting unit 200 when the over-voltage condition in the source voltage VDD is determined, based on the source detection voltage Vdd and the threshold voltage exceeded signal VH.

As an example, the over-voltage protection unit 500 may include a first comparator 510 having a first input terminal that receives the source detection voltage Vdd, a second input terminal that receives the threshold voltage exceeded signal VH, and an output terminal that outputs a comparison result signal of the source detection voltage Vdd and the threshold voltage exceeded signal VH, and a first switch element 520 having a gate connected to the output terminal of the first comparator 510, and a drain and a source that are connected to the source voltage VDD terminal and the gate line GL, respectively.

The first comparator 510 may include an operational amplifier OP1 having a non-inverting input terminal that receives the source detection voltage Vdd, an inverting input terminal that receives the threshold voltage exceeded signal VH, and an output terminal that outputs a comparison result signal of the source detection voltage Vdd and the threshold voltage exceeded signal VH.

The first switch element 520 may include an NMOS transistor NMOS1 having a gate connected to the output terminal of the first comparator 510, a drain connected to the source voltage VDD terminal, and a source connected to the gate line GL.

In this case, in the case in which a level of the source detection voltage Vdd is higher than that of the threshold voltage exceeded signal VH, since the first switch element 520 is switched on by the comparison result signal having a high level and consequently, the source and the gate of the PMOS transistor PM1 (see FIG. 3) of the current adjusting unit 200 have the same potential, the current adjusting unit 200 may stop an operation thereof.

The under-voltage protection unit 600 may shutdown the current adjusting unit 200 when the under-voltage condition in the source voltage is determined, based on the source detection voltage Vdd and the under threshold voltage signal VL.

As an example, the under-voltage protection unit 600 may include a second comparator 610 having a first input terminal that receives the under threshold voltage signal VL, a second input terminal that receives the source detection voltage Vdd, and an output terminal that outputs a comparison result signal of the source detection voltage Vdd and the under threshold voltage signal VL, and a second switch element 620 having a gate connected to the output terminal of the second comparator 610, and a source and a drain that are connected to the source voltage VDD terminal and the gate line GL, respectively.

The second comparator 610 may include an operational amplifier OP2 having a non-inverting input terminal that receives the under threshold voltage signal VL, an inverting input terminal that receives the source detection voltage Vdd, and an output terminal that outputs a comparison result signal of the source detection voltage Vdd and the under threshold voltage signal VL.

The second switch element 620 may include a PMOS transistor PMOS1 having a gate connected to the output terminal of the second comparator 610, a source connected to the source voltage VDD terminal, and a drain connected to the gate line GL.

In this case, in the case in which a level of the source detection voltage Vdd is lower than that of the under threshold voltage signal VL, since the second switch element 620 is switched on by the comparison result signal having a low level and consequently, the source and the gate of the PMOS transistor PM1 (see FIG. 3) of the current adjusting unit 200 have the same potential, the current adjusting unit 200 may stop an operation thereof.

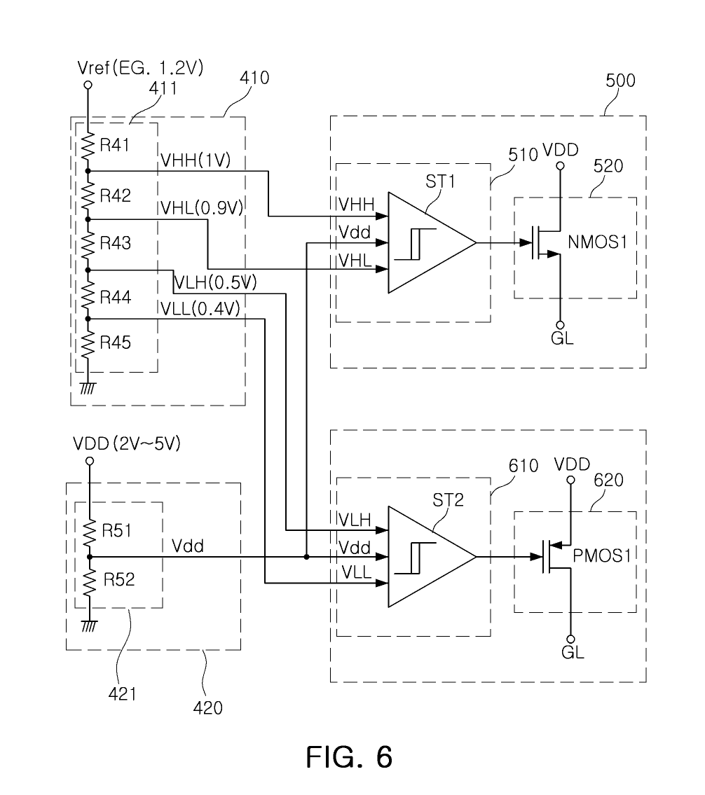

FIG. 6 is a second illustrative implementation diagram for the main parts of the voltage regulator according to an exemplary embodiment of the present disclosure.

Referring to FIG. 6, the threshold voltage generating unit 410 may generate an threshold voltage exceeded signal VHH, a first return-to-normal threshold voltage VHL, an under threshold voltage signal VLL, and a second return-to-normal threshold voltage VLH that are set to be different from each other in advance based on the reference voltage Vref.

Here, the threshold voltage exceeded signal VHH (e.g., 1V) may be a voltage for determining whether or not the source voltage VDD exceeds a normal range (e.g., 2V to 5V), and the first return-to-normal threshold voltage VH (e.g., 0.9V), which is a voltage for determining whether or not the source voltage VDD is again returned to the normal range after the source voltage VDD is determined as the excessive voltage, may be a voltage having a level lower than that of the threshold voltage exceeded signal VHH.

In addition, the second return-to-threshold voltage VLH (e.g., 0.5V) may be a voltage for determining whether or not a level of the source voltage VDD is less than the normal range, and the under threshold voltage signal VLL (e.g., 0.4V), which is a voltage for determining whether or not the source voltage VDD is again returned to the normal range after the source voltage VDD is determined as the under-voltage, may be a voltage having a level higher than that of the under threshold voltage signal VLL.

As illustrated in FIG. 6, the threshold voltage generating unit 410 may include a first voltage dividing circuit 411 having at least five resistors R41, R42, R43, R44, and R45, by way of example.

The first voltage dividing circuit 411 may divide the reference voltage Vref so as to provide the threshold voltage exceeded signal VHH, the first return-to-normal threshold voltage VHL, the under threshold voltage signal VLL, and the second return-to-normal threshold voltage VLH described above.

As an example, the first voltage dividing circuit 411 may provide the threshold voltage exceeded signal VHH at a connection node between the two resistors among the five resistors R41 to R45, provide the first return-to-normal threshold voltage VHL at a connection node between the two resistors R42 and R43 among the five resistors R41 to R45, provide the second return-to-normal threshold voltage VLH at a connection node between the two resistors R43 and R44 among the five resistors R41 to R45, and provide the under threshold voltage signal VLL at a connection node between the two resistors R44 and R45 among the five resistors R41 to R45.

As an example, in the case in which the reference voltage Vref is 1.2V, and each of the five resistors R41 to R45 is set to have 2R, R, 4R, R, and 4R as a relative resistance value, the threshold voltage exceeded signal VHH may be 1V, the first return-to-normal voltage VHL may be 0.9, the second return-to-normal threshold voltage VLH may be 0.5, and the under threshold voltage signal VLL may be 0.4V.

In addition, referring to FIG. 6, the source voltage detecting unit 420 may detect the source voltage VDD so as to provide the source detection voltage Vdd.

As an example, the source voltage detecting unit 420 may include a second voltage dividing circuit 421 having at least two resistors R51 and R52.

The second voltage dividing circuit 421 may divide the source voltage VDD so as to provide the source detection voltage Vdd at a connection node between the at least two resistors R51 and R52.

In addition, referring to FIG. 6, the over-voltage protection unit 500 may shutdown the current adjusting unit 200 when the over-voltage condition in the source voltage VDD is determined, by comparing the source detection voltage Vdd with the threshold voltage exceeded signal VHH and the first return-to-normal threshold voltage VHL, and may release the shutdown of the current adjusting unit 200 when the return of the source voltage VDD to the normal voltage is determined.

As an example, the over-voltage protection unit 500 may include a first hysteresis comparator 510 having a first input terminal that receives the first return-to-normal threshold voltage VHL, a second input terminal that receives the source detection voltage Vdd, a third input terminal that receives the threshold voltage exceeded signal VHH, and an output terminal that outputs a comparison result signal of the source detection voltage Vdd, the threshold voltage exceeded signal VHH, and the first return-to-normal threshold voltage VHL, and a first switch element 520 having a gate connected to the output terminal of the first hysteresis comparator 510, and a drain and a source that are connected to the source voltage VDD terminal and the gate line GL, respectively.

As an implementation example, the first hysteresis comparator 510 may include a first Schmitt-trigger circuit ST1 having a trigger low voltage terminal that receives the first return-to-normal threshold voltage VHL, an input terminal that receives the source detection voltage Vdd, a trigger high voltage terminal that receives the threshold voltage exceeded signal VHH, and an output terminal that outputs a comparison result signal of the source detection voltage Vdd, the threshold voltage exceeded signal VHH, and the first return-to-normal threshold voltage VHL.

The first switch element 520 may include an NMOS transistor NMOS1 having a gate connected to the output terminal of the first hysteresis comparator 510, a drain connected to the source voltage VDD terminal, and a source connected to the gate line.

In this case, in the case in which a level of the source detection voltage Vdd is higher than that of the threshold voltage exceeded signal VH, since the first switch element 520 is switched on by the comparison result signal having a high level and consequently, the source and the gate of the PMOS transistor PM1 (see FIG. 3) of the current adjusting unit 200 have the same potential, the current adjusting unit 200 may stop an operation thereof.

As a result, in the case in which a level of the source detection voltage Vdd is higher than that of the threshold voltage exceeded signal VHH, the over-voltage protection unit 500 may shutdown the current adjusting unit 200 by determining the source detection voltage Vdd as the over-voltage, and in the case in which the source detection voltage Vdd is lower than the first return-to-normal threshold voltage VHL, the over-voltage protection circuit 500 may release the shutdown of the current adjusting unit 200 by determining a return of the source detection voltage Vdd to the normal voltage.

In addition, referring to FIG. 6, the under-voltage protection unit 600 may shutdown the current adjusting unit 200 when the under-voltage condition in the source voltage VDD is determined by comparing the source detection voltage with first and second under threshold voltage signals VL, and may release the shutdown of the current adjusting unit 200 when the return of the source voltage VDD to the normal voltage is determined.

As an example, the under-voltage protection unit 600 may include a second hysteresis comparator 610 having a first input terminal that receives the first under threshold voltage signal VLL, a second input terminal that receives the source detection voltage Vdd, a third input terminal that receives the second return-to-normal threshold voltage VLL, and an output terminal that outputs a comparison result signal of the source detection voltage Vdd, the under threshold voltage signal VLL, and the second return-to-normal threshold voltage VLH, and a second switch element 620 having a gate connected to the output terminal of the second hysteresis comparator 610, and a drain and a source that are connected to the source voltage VDD terminal and the gate line GL, respectively.

As an implementation example, the second hysteresis comparator 610 may include a second Schmitt-trigger circuit ST2 having a trigger low voltage terminal that receives the under threshold voltage signal VLL, an input terminal that receives the source detection voltage Vdd, a trigger high voltage terminal that receives the second return-to-normal threshold voltage VLH, and an output terminal that outputs a comparison result signal of the source detection voltage Vdd, the under threshold voltage signal VLL, and the second return-to-normal threshold voltage VLH.

The second switch element 620 may include a PMOS transistor PMOS1 having a gate connected to the output terminal of the second hysteresis comparator 610, a source connected to the source voltage VDD terminal, and a drain connected to the gate line.

In this case, in the case in which a level of the source detection voltage Vdd is lower than that of the under threshold voltage signal VLL, since the second switch element 620 is switched on by the comparison result signal having a low level and consequently, the source and the gate of the PMOS transistor PM1 (see FIG. 3) of the current adjusting unit 200 have the same potential, the current adjusting unit 200 may stop an operation thereof.

As a result, in the case in which a level of the source detection voltage Vdd is lower than that of the under threshold voltage signal VLL, the over-voltage protection unit 500 may shutdown the current adjusting unit 200 by determining the source detection voltage Vdd as the under-voltage, and in the case in which the source detection voltage Vdd is higher than the second return-to-normal threshold voltage VLH, the over-voltage protection circuit 500 may release the shutdown of the current adjusting unit 200 by determining a return of the source detection voltage Vdd to the normal voltage.

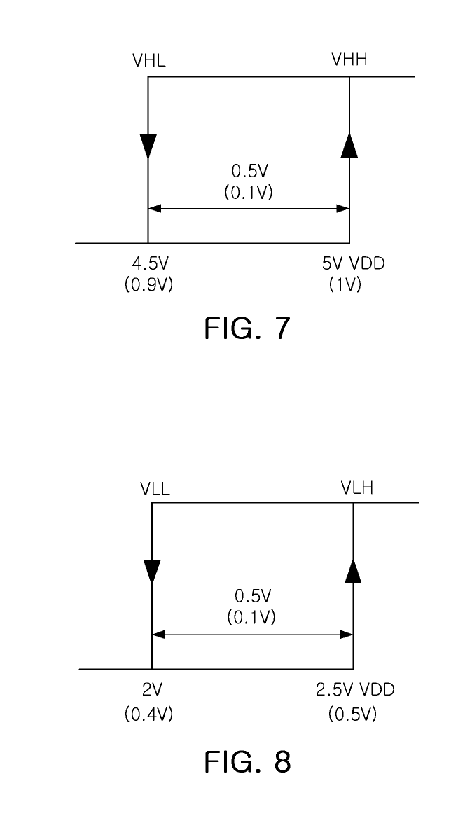

FIG. 7 is a hysteresis curve diagram of an over-voltage protecting unit according to an exemplary embodiment of the present disclosure and FIG. 8 is a hysteresis curve diagram of an under-voltage protecting unit according to an exemplary embodiment of the present disclosure.

Referring to FIG. 7, the first Schmitt-trigger circuit ST1, which is a comparator having hysteresis characteristics, may output a high level signal when a level of the source detection voltage Vdd is higher than that of the threshold voltage exceeded signal VHH (e.g., 1V) and output a low level signal when the power detection voltage Vdd is lower than the first return-to-normal threshold voltage VHL (e.g., 0.9V).

Referring to FIG. 8, the second Schmitt-trigger circuit ST2, which is a comparator having hysteresis characteristics, may output a low level signal when a level of the source detection voltage Vdd is lower than that of the under threshold voltage signal VLL (e.g., 0.4V) and output a high level signal when the power detection voltage Vdd is higher than the second return-to-normal threshold voltage VLH (e.g., 0.5V).

As set forth above, according to exemplary embodiments of the present disclosure, since the voltage regulator autonomously includes the protection function for the over-voltage and the under-voltage of the source voltage, it does not need to include an external protection function, whereby the protection function may be directly and rapidly performed by a simple size, less current consumption, and a simple internal operation as compared to a separate protection circuit which is conventionally provided to the outside of the voltage regulator and as a result, reliability for the protection function may be guaranteed.

While exemplary embodiments have been shown and described above, it will be apparent to those skilled in the art that modifications and variations could be made without departing from the scope of the present invention as defined by the appended claims.

What is claimed is:

1. A voltage regulator, comprising:
an error amplifying unit providing a gate signal depending on a difference in voltage levels between a reference voltage and a feedback voltage;
a current adjusting unit adjusting a current between a source voltage terminal receiving a source voltage and a ground, in response to the gate signal;
a feedback circuit unit detecting the feedback voltage in a feedback node between the current adjusting unit and the ground;
an over-voltage protection unit shutting the current adjusting unit down when an over-voltage condition is detected in the source voltage; and
an under-voltage protection unit shutting the current adjusting unit down when an under-voltage condition is detected in the source voltage.

2. The voltage regulator of claim 1, wherein the over-voltage protection unit generates a threshold voltage exceeded signal based on the reference voltage and determines that the source voltage is in an over-voltage condition based on a level of the source voltage and the threshold voltage exceeded signal.

3. The voltage regulator of claim 1, wherein the under-voltage protection unit generates an under threshold voltage signal based on the reference voltage and determines the under-voltage condition in the source voltage based on a level of the source voltage and the under threshold voltage signal.

4. A voltage regulator, comprising:
an error amplifying unit providing a gate signal depending on a difference in voltage levels between a reference voltage and a feedback voltage;
a current adjusting unit adjusting a current between a source voltage terminal receiving a source voltage and a ground, in response to the gate signal;
a feedback circuit unit detecting the feedback voltage in a feedback node between the current adjusting unit and the ground;
a threshold voltage generating unit generating a threshold voltage exceeded signal and an under threshold voltage signal based on the reference voltage;
a source voltage detecting unit detecting the source voltage to provide a source detection voltage;
an over-voltage protection unit shutting the current adjusting unit down when an over-voltage condition is detected in the source voltage, based on a level of the source detection voltage and the threshold voltage exceeded signal; and
an under-voltage protection unit shutting the current adjusting unit down when an under-voltage condition is detected in the source voltage, based on the source detection voltage and the under threshold voltage signal.

5. The voltage regulator of claim 4, wherein the threshold voltage generating unit generates the threshold voltage exceeded signal and the under threshold voltage signal by dividing the reference voltage using a first voltage dividing circuit including a plurality of resistors.

6. The voltage regulator of claim 4, wherein the source voltage detecting unit provides the source detection voltage by dividing the source voltage using a second voltage dividing circuit including a plurality of resistors.

7. The voltage regulator of claim 4, wherein the over-voltage protection unit determines the source voltage as the over-voltage when the source detection voltage has a level higher than a level of the threshold voltage exceeded signal.

8. The voltage regulator of claim 4, wherein the over-voltage protection unit includes:
a first comparator having a first input terminal receiving the source detection voltage, a second input terminal receiving the threshold voltage exceeded signal, and an output terminal that outputs a comparison result signal of the source detection voltage and the threshold voltage exceeded signal; and
a first switch element having a gate connected to the output terminal of the first comparator, and a drain and a source that are connected to the source voltage terminal and the gate line, respectively, and
wherein the first switch element is switched on in response to the comparison result signal having a high level when a level of the source detection voltage is higher than the threshold voltage exceeded signal, to shutdown the current adjusting unit.

9. The voltage regulator of claim 4, wherein the under-voltage protection unit determines the source voltage as the under-voltage when a level of the source detection voltage is lower than a level of the under threshold voltage signal.

10. The voltage regulator of claim 4, wherein the under-voltage protection unit includes:
a second comparator having a first input terminal receiving the under threshold voltage signal, a second input terminal receiving the source detection voltage, and an output terminal that outputs a comparison result signal of the source detection voltage and the under threshold voltage signal; and
a second switch element having a gate connected to the output terminal of the second comparator, and a source and a drain that are connected to the source voltage terminal and the gate line, respectively, and
wherein the second switch element is switched on in response to the comparison result signal having a low level when a level of the source detection voltage is lower than a level of the under threshold voltage signal, to shutdown the current adjusting unit.

11. A voltage regulator, comprising:
an error amplifying unit providing a gate signal depending on a difference in voltage levels between a reference voltage and a feedback voltage;
a current adjusting unit adjusting a current between a source voltage terminal receiving a source voltage and a ground in response to the gate signal;
a feedback circuit unit detecting the feedback voltage in a feedback node between the current adjusting unit and the ground;
a threshold voltage generating unit generating a threshold voltage exceeded signal, a first return-to-normal threshold voltage, an under threshold voltage signal, and a second return-to-normal threshold voltage which are set to have voltage levels different from each other in advance, based on the reference voltage;
a source voltage detecting unit detecting the source voltage to provide a source detection voltage;
an over-voltage protection unit comparing a level of the source detection voltage with levels of the threshold voltage exceeded signal and the first return-to-normal threshold voltage to shutdown the current adjusting unit when an over-voltage condition is detected in the source voltage and to release the shunt down of the current adjusting unit when a return of the source voltage to a normal voltage is determined; and
an under-voltage protection unit comparing a level of the source detection voltage with levels of first and second under threshold voltages to shutdown the current adjusting unit when an under-voltage condition in the source voltage is detected and to release the shunt down of the current adjusting unit when a return of the source voltage to a normal voltage is determined.

12. The voltage regulator of claim 11, wherein the threshold voltage generating unit has a source voltage protection function that generates the threshold voltage exceeded signal, the first return-to-normal threshold voltage, the under threshold voltage signal, and the second return-to-normal threshold voltage by dividing the reference voltage using a first voltage dividing circuit including a plurality of resistors.

13. The voltage regulator of claim 11, wherein the source voltage detecting unit provides the source detection voltage by dividing the source voltage using a second voltage dividing circuit including a plurality of resistors.

14. The voltage regulator of claim 11, wherein the threshold voltage exceeded signal is a voltage for determining whether or not a level of the source voltage exceeds a normal range to which the source voltage belongs, and
the first return-to-normal threshold voltage is a voltage for determining a return of the source voltage to the normal range after the source voltage is determined as an excessive voltage, and has a level lower than a level of the threshold voltage exceeded signal.

15. The voltage regulator of claim 11, wherein the over-voltage protection unit shuts down the current adjusting unit by determining the source detection voltage as the over-voltage when a level of the source detection voltage is higher than a level of the threshold voltage exceeded signal and releases the shutdown of the current adjusting unit by determining the return to the normal voltage when the source detection voltage is lower than the first return-to-normal threshold voltage.

16. The voltage regulator of claim 11, wherein the over-voltage protection unit includes:
a first hysteresis comparator having a first input terminal receiving the first return-to-normal threshold voltage, a second input terminal receiving the source detection voltage, a third input terminal receiving the threshold voltage exceeded signal, and an output terminal that outputs a comparison result signal of the source detection voltage, the threshold voltage exceeded signal, and the first return-to-normal threshold voltage; and
a first switch element having a gate connected to the output terminal of the first hysteresis comparator, and a drain and a source that are connected to the source voltage terminal and the gate line, respectively, and
wherein the over-voltage protection unit shuts down the current adjusting unit by determining the source detection voltage as the over-voltage when a level of the source detection voltage is higher than a level of the threshold voltage exceeded signal and releases the shutdown of the current adjusting unit by determining a return of the source detection voltage to a normal voltage when the source detection voltage is lower than the first return-to-normal threshold voltage.

17. The voltage regulator of claim 11, wherein the under threshold voltage signal is a voltage for determining whether or not a level of the source voltage is less than a normal range to which the source voltage belongs, and
the second return-to-normal threshold voltage is a voltage for determining a return of the source voltage to the normal range after the source voltage is detected as the under-voltage, and has a level higher than a level of the under threshold voltage signal.

18. The voltage regulator of claim 11, wherein the under-voltage protection unit shuts down the current adjusting unit by determining the source detection voltage as the under-voltage when a level of the source detection voltage is lower than a level of the under threshold voltage signal and releases the shutdown of the current adjusting unit by determining the return of the source detection voltage to the normal voltage when the source detection voltage is higher than the second return-to-normal threshold voltage.

19. The voltage regulator of claim 11, wherein the under-voltage protection unit includes:
a second hysteresis comparator having a first input terminal receiving the under threshold voltage signal, a second input terminal receiving the source detection voltage, a third input terminal receiving the second return-to-normal threshold voltage, and an output terminal that outputs a comparison result signal of the source detection voltage, the under threshold voltage signal, and the second return-to-normal threshold voltage; and
a second switch element having a gate connected to the output terminal of the second hysteresis comparator, and a source and a drain that are connected to the source voltage terminal and the gate line, respectively, and
wherein the under-voltage protection unit shuts down the current adjusting unit by determining the source detection voltage as the under-voltage when a level of the source detection voltage is lower than a level of the under threshold voltage signal and releases the shutdown of the current adjusting unit by determining a return of the source detection voltage to a normal voltage when the source detection voltage is lower than the second return-to-normal threshold voltage.
